(19) United States
(12) Patent Application Publication
(10) Pub. No.: US 2007/0226188 A1
(43) Pub. Date: Sep. 27, 2007

(54) Method and apparatus for data stream sampling

(76) Inventors: Theodore Johnson, New York, NY (US); Shanmugavelayutham Muthukrishnan, Washington, DC (US); Irina Rozenbaum, Monmouth Junction, NJ (US)

Correspondence Address: AT&T CORP., ROOM 2A207, ONE AT&T WAY, BEDMINSTER, NJ, 07921, US

(21) Appl. No.: 11/389,851

(22) Filed: Mar. 27, 2006

(51) Int. Cl. G06F 17/30

(52) U.S. Cl. 707/3

(57) ABSTRACT

In one embodiment, the present invention is a method and apparatus for data stream sampling. In one embodiment, a tuple of a data stream is received from a sampling window of the data stream. The tuple is associated with a group, selected from a set of one or more groups, which reflects a subset of information relating to a sample of the data stream. In addition, the tuple is associated with a supergroup, selected from a set of one or more supergroups, which reflects global information relating to the sample. It is then determined whether receipt of the tuple triggers a cleaning phase in which one or more tuples are shed from the sample. The operator can be implemented to execute a variety of different sampling algorithms, including well-known and experimental algorithms.

### FIELD OF THE INVENTION

The present invention relates generally to data stream processing and relates more particularly to techniques for sampling data streams.

### BACKGROUND OF THE INVENTION

Many applications (e.g., network monitoring, financial monitoring, sensor networks, large-scale scientific data feed processing, etc.) produce data in the form of high-speed streams. Often, the speed of these streams is so high that the streams cannot be stored (e.g., for later analysis) at a matching rate. Thus, in order to efficiently analyze the data in a high-speed stream, many applications rely on sampling, wherein only a subset of the data in the stream is analyzed. The sample subset is representative of the overall stream and is typically suitable for different processing purposes.

Many sampling methods are currently in use and vary in sophistication. However, in a typical data stream management system it is difficult to implement some of the more sophisticated methods, or to implement multiple methods. Moreover, many known sampling methods are difficult to scale to different speeds, such as line speeds in IP networks.

Thus, there is a need in the art for a method and apparatus for data stream sampling.

### SUMMARY OF THE INVENTION

In one embodiment, the present invention is a method and apparatus for data stream sampling. In one embodiment, a tuple of a data stream is received from a sampling window of the data stream. The tuple is associated with a group, selected from a set of one or more groups, which reflects a subset of information relating to a sample of the data stream. In addition, the tuple is associated with a supergroup, selected from a set of one or more supergroups, which reflects global information relating to the sample. It is then determined whether receipt of the tuple triggers a cleaning phase in which one or more tuples are shed from the sample. The operator can be implemented to execute a variety of different sampling algorithms, including well-known and experimental algorithms.

### BRIEF DESCRIPTION OF THE DRAWINGS

The teaching of the present invention can be readily understood by considering the following detailed description in conjunction with the accompanying drawings, in which:

FIGS. 1A-1B comprise a flow diagram illustrating one embodiment of a stream operator for sampling data streams, according to the present invention; and

FIG. 2 is a high level block diagram of the data stream sampling operator that is implemented using a general purpose computing device.

To facilitate understanding, identical reference numerals have been used, where possible, to designate identical elements that are common to the figures.

### DETAILED DESCRIPTION

In one embodiment, the present invention relates to the sampling of data streams. Embodiments of the invention provide an operator that enables the implementation of a variety of different sampling algorithms in a data stream management system. The novel operator may be easily scaled, through definition of variables, to implement known sampling algorithms. However, the operator is also versatile enough to allow for experimentation with new sampling algorithms.

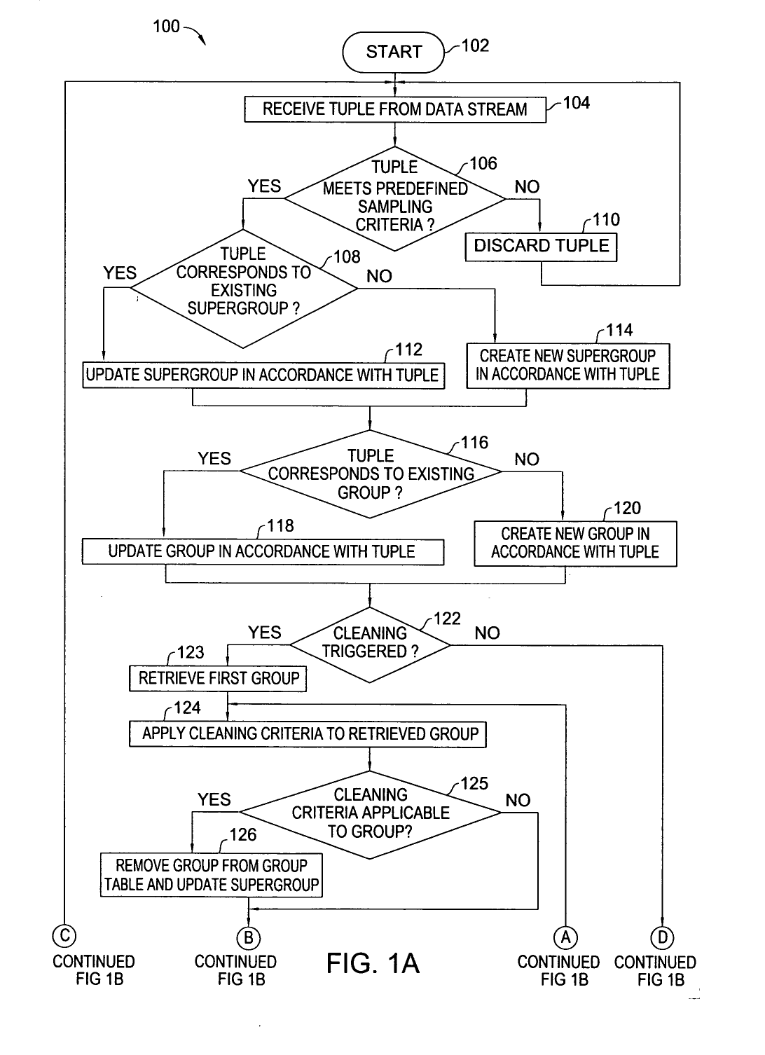

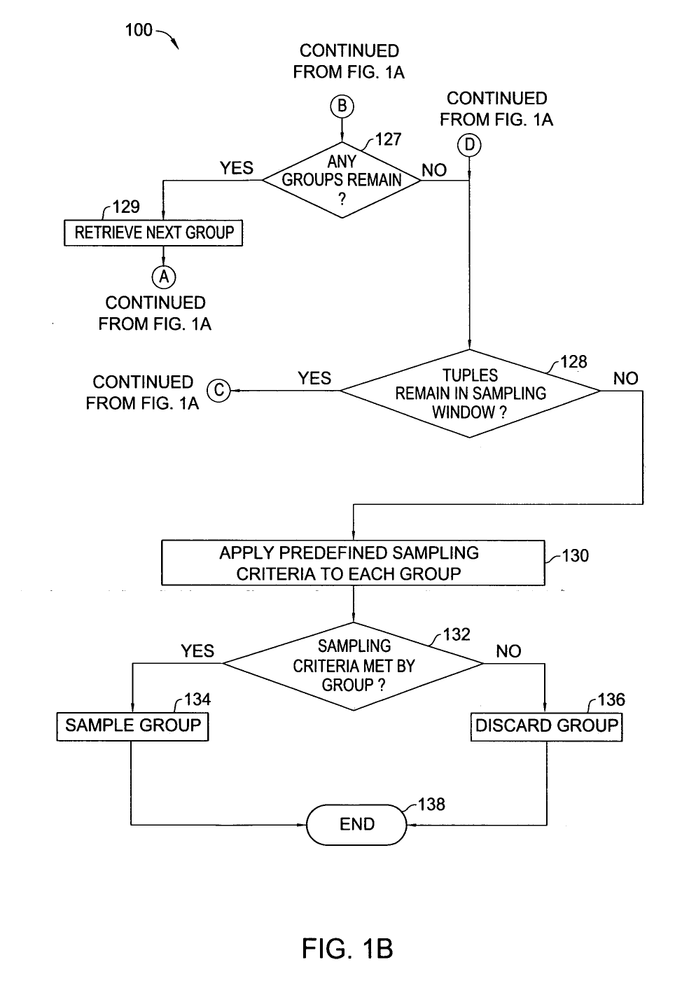

FIGS. 1A-1B comprise a flow diagram illustrating one embodiment of a stream operator 100 for sampling data streams, according to the present invention. The stream operator 100 may be implemented, for example, in a data stream management system. The operator 100 selects sample tuples or individual records from windows (e.g., dimensional subsets) of an incoming data stream.

The operator 100 is initialized at step 102 and proceeds to step 104, where the operator 100 receives a new tuple from a monitored data stream. The tuple is associated with a key (i.e., one or more tuple properties), which determines which aggregate and superaggregate structures the tuple is associated with, as described in further detail below.

In step 106, the operator 100 determines whether the received tuple meets one or more predefined sampling criteria (e.g., criteria for selecting tuples for sampling from the data stream). If the operator 100 concludes in step 106 that the tuple does not meet the predefined sampling criteria, the operator 100 discards the tuple in step 110 before returning to step 104 and proceeding as described above to analyze the next tuple. The discarded tuple will not be part of the sample.

Alternatively, if the operator 100 concludes in step 106 that the tuple does meet the predefined sampling criteria, the operator 1 00 proceeds to step 108 and determines whether the tuple corresponds to an existing supergroup. A supergroup is a global aggregate (i.e., relating to the collection of all samples) defined by sampling state variables (e.g., control variables such as a count of tuples processed since a last cleaning phase, a number of cleaning phases triggered, etc.) for the sampling process. These variables are defined by a key associated with the supergroup, as discussed in further detail below. The maintenance of supergroups facilitates sampling on a group-wise basis (e.g., for each source IP address, report the destination IP addresses accounting for at least ten percent of the total packets sent from the source IP address). For example, in accordance with the known subset-sum sampling algorithm, a supergroup might maintain information for all distinct active groups (since a cleaning phase, as discussed in greater detail below, is triggered when the total number of distinct groups exceeds a predefined threshold). In accordance with the known min-hash algorithm, a supergroup might maintain k number of min-hash destination IP addresses per source IP address, such that a k^{th} smallest value can be identified.

In addition, a supergroup is capable of computing superaggregates (i.e., aggregates of supergroups, such as an aggregate that counts a number of distinct groups in a supergroup). For example, a useful superaggregate is count_distinct$( ), which reports the number of groups in a supergroup. A determination as to which supergroup a tuple corresponds is made in accordance with the tuple's key and the supergroup's key. If the operator 100 concludes in step 108 that the tuple does not correspond to an existing supergroup, the operator 100 proceeds to step 114 and creates a new supergroup in accordance with the tuple. That is, the operator 100 creates a new supergroup defined by the properties of the tuple, with the tuple as the first member of the supergroup. The creation of the new supergroup and its associated key are reflected in a hash table, as described in further detail below.

In one embodiment, the tuple may correspond to a supergroup that existed in a previous sampling window. In such an instance, the state of the supergroup from the previous sampling window is initialized in a hash table, and a pointer associated with the supergroup is pointed to the previous state, as described in further detail below.

If, on the other hand, the operator 100 concludes in step 108 that the tuple does correspond to an existing supergroup, the operator 100 updates the corresponding supergroup in accordance with the tuple (e.g., accounts for the tuple in one or more values associated with the supergroup) in step 112. The update is reflected in a hash table for the supergroup, as described in further detail below.

Once the tuple has been associated with either an existing supergroup (i.e., in accordance with step 112) or a new supergroup (i.e., in accordance with step 114), the operator 100 proceeds to step 116 and determines whether the tuple corresponds to an existing group (i.e., sample) within the associated supergroup. Correspondence with a group is defined by the tuple's key and by a key associated with a group. That is, each group is defined by a key that is shared by all members (tuples) of the group. Thus, for the tuple to correspond to an existing group, the tuple must include the key shared by members of the group. If the operator 100 concludes in step 116 that the tuple does not correspond to an existing group, the operator 100 proceeds to step 120 and creates a new group in accordance with the tuple. That is, the operator 100 creates a new group defined by the properties of the tuple, with the tuple as the first member of the group. In such an instance, a corresponding supergroup aggregate is updated by adding a current group aggregate value (this helps to maintain a superaggregate, as group aggregates of the same type must be maintained). The creation of the new group and its associated key, as well as the superaggregate update, are reflected in a hash table, as described in further detail below.

If, on the other hand, the operator 100 concludes in step 116 that the tuple does correspond to an existing group, the operator 100 updates the corresponding group in accordance with the tuple (e.g., accounts for the tuple in one or more values associated with the group) in step 118. The update is reflected in a hash table for the group, as described in further detail below.

Once the tuple has been associated with either an existing group (i.e., in accordance with step 118) or a new group (i.e., in accordance with step 120), the operator 100 proceeds to step 122 and determines whether a cleaning phase has been triggered by the update of the group(s). A cleaning phase applies to a supergroup state and is triggered by predefined criteria that dictate when a quantity of stored tuples should be discarded or shed from the sample (e.g., to make room for new tuples in a sample of fixed size). For example, in the subset-sum sampling algorithm, a cleaning phase is triggered when the current number of active groups exceeds a predefined threshold (or technically, the current number of packets exceeds the threshold, because in accordance with the subset-sum algorithm, each packet must be distinctly unique and thus each group consists of a single packet).

If the operator 100 concludes in step 122 that a cleaning phase has been triggered, the operator 100 proceeds to step 123 and retrieves a first group (e.g., from the current supergroup). In step 124, the operator 100 applies the predefined cleaning criteria to the retrieved group.

In step 125, the operator 100 determines whether the cleaning criteria are applicable to the current group (i.e., whether the tuples in the current group should be “cleaned” or shed in accordance with the cleaning criteria). If the operator 100 concludes in step 125 that the cleaning criteria are applicable to the current group, the operator 100 proceeds to step 126 and removes the current group from the corresponding group hash table (described in further detail below) and updates any corresponding superaggregates associated with the sample. This helps to maintain the superaggregates, as group aggregates of the same type must be maintained.

In step 127, the operator 100 determines whether there are any groups remaining in the corresponding group hash table. Note that if the operator determined in step 125 that the cleaning criteria are not applicable to the current group, the operator 100 bypasses step 126 and proceeds directly to step 127.

If the operator 100 concludes in step 127 that there is at least one remaining group in the corresponding group hash table, the operator 100 proceeds to step 129 and retrieves the next group from the corresponding group hash table. The operator 100 then returns to step 124 and proceeds as described above to apply the cleaning criteria to the retrieved group.

Alternatively, if the operator 100 concludes in step 127 that there are no remaining groups in the corresponding group hash table, the operator 100 proceeds to step 128 and determines whether any tuples remain in the window being sampled. If the operator 100 concludes in step 128 that there is one or more tuples remaining in the sampling window, the operator 100 returns to step 104 and proceeds as described above to process the next tuple.

Alternatively, if the operator 100 concludes that there are no tuples remaining in the sampling window, the operator 100 applies one or more predefined sampling criteria to each group maintained by the group table. The predefined sampling criteria determine whether the tuples in a group should be part of the final sample.

If the operator 100 concludes in step 132 that a group meets the predefined sampling criteria, the operator 100 proceeds to step 134 and samples the group. Alternatively, if the operator 100 concludes in step 132 that the group does not meet the predefined sampling criteria, the operator 100 proceeds to step 136 and discards the group. Thus, the group is not sampled. After each group is sampled (i.e., in accordance with step 134) or discarded (i.e., in accordance with step 136), the operator 100 terminates in step 138. The operator 100 may be restarted to process additional sampling windows as required.

Thus, one embodiment of a textual representation of the operator 100 could be expressed as:

SELECT <select expression list>
FROM <stream>
WHERE <predicate>
GROUP BY <group-by variables definition list>
[SUPERGROUP <group-by variable list>]
[HAVING <predicate>]
CLEANING WHEN <predicate>
CLEANING BY <predicate>

The operator 100 thereby provides a single framework for the implementation of a variety of different sampling algorithms in a data stream management system. For example, the operator 100 may be easily scaled, through definition of variables (e.g., predefined sampling criteria, cleaning criteria, etc.) to implement known sampling algorithms such as subset-sum sampling algorithms, heavy hitters algorithms, min-hash algorithms and reservoir sampling algorithms. However, the operator 100 is also versatile enough to allow for experimentation with new sampling algorithms. The operator 100 is also efficient enough to implement in a high-speed stream databases.

In one embodiment, the operator 100 further supports algorithms wherein initial values of a state in a new sampling window are derived from a final state of the immediately preceding sampling window (e.g., such as dynamic subset-sum sampling). In this embodiment, the operator 100 accomplishes this by checking for a supergroup having the same non-ordered group-by (key) variables as a previous sampling window. In such an instance, all states in the current superaggregate are initialized by a function that accepts the equivalent state from the previous sampling window.

For instance, an exemplary implementation of the operator 100, to express a dynamic subset-sum sampling algorithm that collects 100 samples, could be expressed as:

SELECT uts, srcIP, destIP, UMAX(sum(len), ssthreshold( ))
FROM PKTS
WHERE ssample(len, 100) = TRUE
GROUP BY time/20 as tb, srcIP, destIP, uts
HAVING ssfinal_clean(sum(len), count_distinct$(*)) = TRUE
CLEANING WHEN ssdo_clean(count_distinct$(*)) = TRUE
CLEANING BY ssclean_with(sum(len)) = TRUE

where UMAX(val1, val2) is a function that returns the maximum of two values val1 and val2 (i.e., sum(olen) and ssthreshold( ) in the above example), and uts is a nanosecond granularity timestamp (with its timestamp-ness cast away) used to make each tuple its own group.

To implement some sampling algorithms in accordance with the operator 100, some functions, hereinafter referred to as “stateful functions”, will need to access a global state function throughout execution. These stateful functions return Boolean (e.g., true/false) values. In the above example, the functions ssthreshold( ), ssample( ), ssfinal_clean( ), ssdo_clean( ) and ssclean_with( ) are such stateful functions.

Stateful functions help to maintain global information and are similar to user-defined aggregate functions (UDAFs), but, unlike UDAFs, stateful functions can produce output a plurality of times during execution. Moreover, a state can be modified only when the functions that share the state are referenced. A state may be expressed as: STATE <type> <name>. Accordingly, a declaration of a stateful function ties the stateful function to the state it shares, e.g.: SFUN <type> [modifiers] <state_name> <function_name> (<param_list>).

For example, a stateful function, represented as SFUN, could be implemented in accordance with the operator 100 to express a subset-sum sampling algorithm as:

STATE char[50] subsetsum_sampling_state;
SFUN int subsetsum_sampling_state ssample(int, CONST int);
SFUN int subsetsum_sampling_state ssfinal_clean (int, int);
SFUN int subsetsum_sampling_state ssdo_clean (int);
SFUN int subsetsum_sampling_state ssclean_with (int);
SFUN int subsetsum_sampling_state ssthreshold( );

When the query references a new supergroup, the space for the SFUN state is allocated to the superaggregate structure. The state is initialized with its associated initialization function. For example, a prototype of the state initialization function in an implementation of the operator 100 could be expressed as:

void_sfun_state_init_<state name>(<pointer to memory for the state>,
<pointer to

old state, or NULL>);

Stateful functions are implicitly passed a pointer to their associated state. In one embodiment, a prototype for a stateful function can be expressed as:
<return type> <name> (void*s, <param_list>);

where s is the pointer to the associated state. In the exemplary case of the subset-sum implementation above, some stateful functions that may be added to a system library include:

void_sfun_state_init_subsetsum_sampling_state (void* n, void* o);

int ssample (void*s, int len, int sample_size);

Stateful functions that appear in the SELECT clause of the above example are evaluated as a last step in the execution of the operator 100, when an output tuple is created.

To assist in implementation, the operator 100 maintains, throughout execution, three types of hash tables: a first hash table for tracking groups (i.e., subsets of tuples sharing a common key), a second table for tracking supergroups (i.e., global aggregate structures) and a third hash table for tracking all groups associated with every supergroup.

Each hash table lists at least two features: a key and a value. For the first hash table, which tracks groups, the key is a set of group-by variables for tuples in a group, and the value is a structure that maintains groups aggregates. For the second hash table, which tracks supergroups, the key is a set of supergroup variables not including ordered variables (when no supergroup is specified, the key is associated with a single sampling window), and the value is a structure that maintains state(s) associated with the supergroup and any superaggregates. The key of the second table will be a subset of elements that represent the key of the first table. In addition, the second hash table may be divided into two-sub-tables: an “old” supergroup sub-table (for maintaining all supergroups sampled in a previous sampling window) and a “new” supergroup sub-table (for maintaining all supergroups sampled in the current sampling window). For the third hash table, which tracks groups within a supergroup, the key is a set of supergroup variables (when no supergroup is specified, the key is associated with a single sampling window), and the value is a list of all groups in a given supergroup.

For example, if a received tuple is the last in the current sampling window, a function can be invoked that will clear the group table, the old supergroup sub-table and the groups in supergroup table. This function will also apply a predefined sampling criteria (i.e., the HAVING clause in the above examples) to the new supergroup sub-table before making the new supergroup sub-table the current old supergroup sub-table. (e.g., in accordance with steps 130-138 of the operator 100).

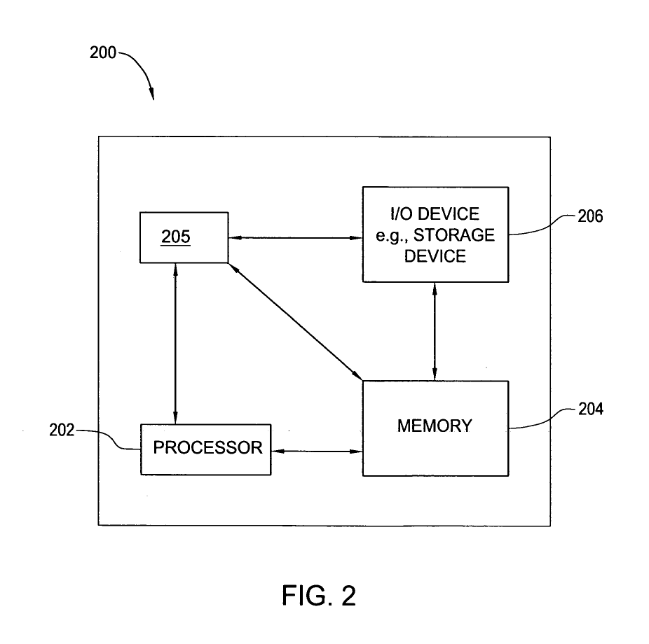

FIG. 2 is a high level block diagram of the data stream sampling operator that is implemented using a general purpose computing device 200. In one embodiment, a general purpose computing device 200 comprises a processor 202, a memory 204, a sampling module 205 and various input/output (I/O) devices 206 such as a display, a keyboard, a mouse, a modem, and the like. In one embodiment, at least one I/O device is a storage device (e.g., a disk drive, an optical disk drive, a floppy disk drive). It should be understood that the sampling module 205 can be implemented as a physical device or subsystem that is coupled to a processor through a communication channel.

Alternatively, the sampling module 205 can be represented by one or more software applications (or even a combination of software and hardware, e.g., using Application Specific Integrated Circuits (ASIC)), where the software is loaded from a storage medium (e.g., I/O devices 206) and operated by the processor 202 in the memory 204 of the general purpose computing device 200. Thus, in one embodiment, the sampling module 205 for sampling a data stream described herein with reference to the preceding Figures can be stored on a computer readable medium or carrier (e.g., RAM, magnetic or optical drive or diskette, and the like).

Thus, the present invention represents a significant advancement in the field of data stream processing. A single framework is provided for the implementation of a variety of different sampling algorithms in a data stream management system. For example, the operator may be easily scaled, through definition of variables, to implement known sampling algorithms such as subset-sum sampling algorithms, heavy hitters algorithms, min-hash algorithms and reservoir sampling algorithms. However, the operator is also versatile enough to allow for experimentation with new sampling algorithms.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for sampling a data stream comprising a plurality of tuples, the operator comprising:
receiving one of said plurality of tuples, said one of said plurality of tuples belonging to a first sampling window;
associating said one of said plurality of tuples with a group, selected from a set of one or more groups, that reflects a subset of information relating to a sample of said data stream;
associating said one of said plurality of tuples with a supergroup, selected from a set of one or more supergroups, that reflects global information relating to said sample; and
applying one or more cleaning criteria to each of said one or more groups, if reception of said one of said plurality of tuples triggers a cleaning phase.

2. The method of claim 1, wherein said receiving comprises:
processing said one of said plurality of tuples, if said one of said plurality of tuples satisfies one or more predefined sampling criteria; and
discarding said one of said plurality of tuples, if said one of said plurality of tuples does not satisfy said one or more predefined sampling criteria.

3. The method of claim 1, wherein said associating said one of said plurality of tuples with a group comprises:
identifying a group defined by a key that is associated with said one of said plurality of tuples.

4. The method of claim 1, wherein said associating said one of said plurality of tuples with a group comprises:
creating a new group defined by a key that is associated with said one of said plurality of tuples.

5. The method of claim 1, wherein said associating said one of said plurality of tuples with a supergroup comprises:
identifying a supergroup defined by a key that is associated with said one of said plurality of tuples.

6. The method of claim 1, wherein said associating said one of said plurality of tuples with a supergroup comprises:
creating a new supergroup defined by a key that is associated with said one of said plurality of tuples.

7. The method of claim 1, further comprising:
applying one or more sampling criteria to each of said one or more groups;
sampling each of said one or more groups that satisfies said sampling criteria; and
discarding each of said one or more groups that does not satisfy said sampling criteria.

8. The method of claim 1, wherein said global information is maintained by one or more stateful functions, said one or more stateful functions requiring access a global state function throughout execution of said operator.

9. The method of claim 1, further comprising:
applying one or more cleaning criteria to each of said one or more groups, if reception of said one of said plurality of tuples triggers a cleaning phase.

10. A computer readable medium containing an executable program for sampling a data stream comprising a plurality of tuples, where the program performs the steps of:
receiving one of said plurality of tuples, said one of said plurality of tuples belonging to a first sampling window;
associating said one of said plurality of tuples with a group, selected from a set of one or more groups, that reflects a subset of information relating to a sample of said data stream;
associating said one of said plurality of tuples with a supergroup, selected from a set of one or more supergroups, that reflects global information relating to said sample; and
applying one or more cleaning criteria to each of said one or more groups, if reception of said one of said plurality of tuples triggers a cleaning phase.

11. The computer readable medium of claim 10, wherein said receiving comprises:
processing said one of said plurality of tuples, if said one of said plurality of tuples satisfies one or more predefined sampling criteria; and
discarding said one of said plurality of tuples, if said one of said plurality of tuples does not satisfy said one or more predefined sampling criteria.

12. The computer readable medium of claim 10, wherein said associating said one of said plurality of tuples with a group comprises:
identifying a group defined by a key that is associated with said one of said plurality of tuples.

13. The computer readable medium of claim 10, wherein said associating said one of said plurality of tuples with a group comprises:
creating a new group defined by a key that is associated with said one of said plurality of tuples.

14. The computer readable medium of claim 10, wherein said associating said one of said plurality of tuples with a supergroup comprises:
identifying a supergroup defined by a key that is associated with said one of said plurality of tuples.

15. The computer readable medium of claim 10, wherein said associating said one of said plurality of tuples with a supergroup comprises:
creating a new supergroup defined by a key that is associated with said one of said plurality of tuples.

16. The computer readable medium of claim 10, further comprising:
applying one or more cleaning criteria to each of said one or more groups, if reception of said one of said plurality of tuples triggers a cleaning phase.

17. The computer readable medium of claim 10, further comprising:
applying one or more sampling criteria to each of said one or more groups;
sampling each of said one or more groups that satisfies said sampling criteria; and
discarding each of said one or more groups that does not satisfy said sampling criteria.

18. The computer readable medium of claim 10, wherein said global information is maintained by one or more stateful functions, said one or more stateful functions requiring access a global state function throughout execution of said operator.

19. An apparatus for sampling a data stream comprising a plurality of tuples, the apparatus comprising:
means for receiving one of said plurality of tuples, said one of said plurality of tuples belonging to a first sampling window;
means for associating said one of said plurality of tuples with a group, selected from a set of one or more groups, that reflects a subset of information relating to a sample of said data stream; and
means for associating said one of said plurality of tuples with a supergroup, selected from a set of one or more supergroups, that reflects global information relating to said sample; and
means for applying one or more cleaning criteria to each of said one or more groups, if reception of said one of said plurality of tuples triggers a cleaning phase.

20. The apparatus of claim 19, wherein said means for receiving comprises:
means for processing said one of said plurality of tuples, if said one of said plurality of tuples satisfies one or more predefined sampling criteria; and
means for discarding said one of said plurality of tuples, if said one of said plurality of tuples does not satisfy said one or more predefined sampling criteria.
